(19) United States
(12) Patent Application Publication
(10) Pub. No.: US 2007/0168505 A1
(43) Pub. Date: Jul. 19, 2007

(54) PERFORMANCE MONITORING IN A NETWORK

(75) Inventors: Madan Gopal DEVADOSS, Bangalore Karnataka (IN); Prem Monica N RAJ, Bangalore Karnataka (IN); Harish SUBRAMANIAN, Bangalore Karnataka (IN)

Correspondence Address: MR. ROBERT L. STOCK, 746 WEST CARLTON, ONTARIO, CA, 91762, US

(73) Assignee: HEWLETT-PACKARD DEVELOPMENT COMPANY, L.P., Houston, TX (US)

(21) Appl. No.: 11/622,079

(22) Filed: Jan. 11, 2007

(30) Foreign Application Priority Data
Jan. 19, 2006 (IN) 89/CHE/2006

(51) Int. Cl. G06F 15/173

(52) U.S. Cl. 709/224

(57) ABSTRACT

Real time status changes of network elements in a network are reported and correlated, to help in eliminating events that are not of interest and to annotate or generate events that provide more useful information to the network operator. The result of the correlation can also be used to intelligently trigger further performance data collection to more precisely determine the level of performance degradation resulting from a status change.

### FIELD OF THE INVENTION

The present invention relates to performance monitoring in a network.

### BACKGROUND

As computer and communication networks become increasingly ubiquitous, the challenge for network operators is to improve network performance and network management. Many tools are available for analysing and reporting on network performance.

A conventional network management system is capable of receiving event information about a plurality of network elements, including servers, routers, switches and so on, and passing the information to an event correlation tool. The event correlation tool can process the event information according to a set of correlation rules, for example to eliminate events that are not of interest based on other event information received.

### SUMMARY OF THE INVENTION

According to the present invention, there is provided a method of monitoring performance in a network, comprising collecting performance data from the network, generating events based on the performance data, correlating the events and initiating further collection of performance data in dependence on the result of the correlation.

By intelligently triggering the collection of further performance data based on the result of the correlation, a more precise determination may be possible as to the level of performance degradation associated with a status change relating to a network element in the network.

The intelligent triggering of further performance monitoring can therefore allow the system to drill down to determine further performance degradations starting from an initial degradation assessment.

The data may comprise information relating to a plurality of performance metrics, and the step of initiating collection of further performance data may comprise initiating monitoring of a further performance metric.

The method may further comprise receiving the further performance metric, generating further events based on said performance metric and correlating the events with the further events. It may further comprise initiating one or more further stages of performance data collection in dependence on the result of said correlation.

An event may be generated when the performance data breaches a predetermined threshold value.

There is no limit to the number of stages of further data collection that can be triggered in an effort to pinpoint a particular problem in a network.

According to the invention, there is further provided a system for monitoring performance in a network, comprising means for collecting performance data from the network, means for generating events based on the performance data, means for correlating the events and means for initiating further collection of performance data in dependence on the result of the correlation.

The correlating means may be arranged to correlate the events based on correlation rules stored in a correlation database.

The performance data may comprise one or more performance metrics relating to one more network elements, which may comprise one or more elements selected from the group comprising servers, switches, routers and network interfaces.

The correlating means may be arranged to receive the events from the generating means and may be further arranged to receive events from sources external to the generating means. The correlating means may be arranged to correlate the events received from the generating means with the events generated from sources external to the generating means.

According to the invention, there is also provided a system for monitoring performance in a network, comprising a performance monitor for collecting performance data relating to network elements in the network and for generating event data based on said performance data and an event correlator for receiving the event data from the performance monitor and for correlating the event data, wherein the event correlator is arranged to instruct the performance monitor to initiate further collection of further performance data in dependence on the result of the correlation.

The event correlator may be arranged to receive external event data from sources external to the performance monitor and to correlate the event data generated by the performance monitor with the external event data. The performance monitor may also be arranged to generate further event data based on the further performance data and the event correlator may be arranged to correlate the event data and/or the external event data with the further event data.

The data may comprise real time performance metrics based on information relating to real time status changes at the network elements. The performance monitor may generate events including real time performance data.

### BRIEF DESCRIPTION OF THE DRAWINGS

FIG. 1 is a schematic diagram of a system according to an embodiment of the invention for performing network monitoring and event correlation;

FIG. 2 is a flowchart illustrating a method of performing network monitoring and event correlation according to an embodiment of the invention;

FIG. 3 is a flowchart illustrating a method of performing network monitoring and event correlation according to another embodiment of the invention;

FIG. 4 is a flowchart illustrating a method of performing network monitoring and event correlation according to another embodiment of the invention;

FIG. 5 is a flowchart illustrating a method of performing network monitoring and event correlation according to another embodiment of the invention; and

FIG. 6 is a flow chart illustrating a method of performing network monitoring and event correlation according to another embodiment of the invention.

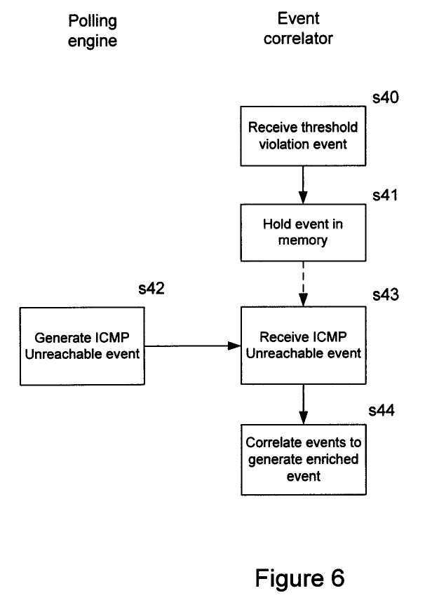

### DETAILED DESCRIPTION

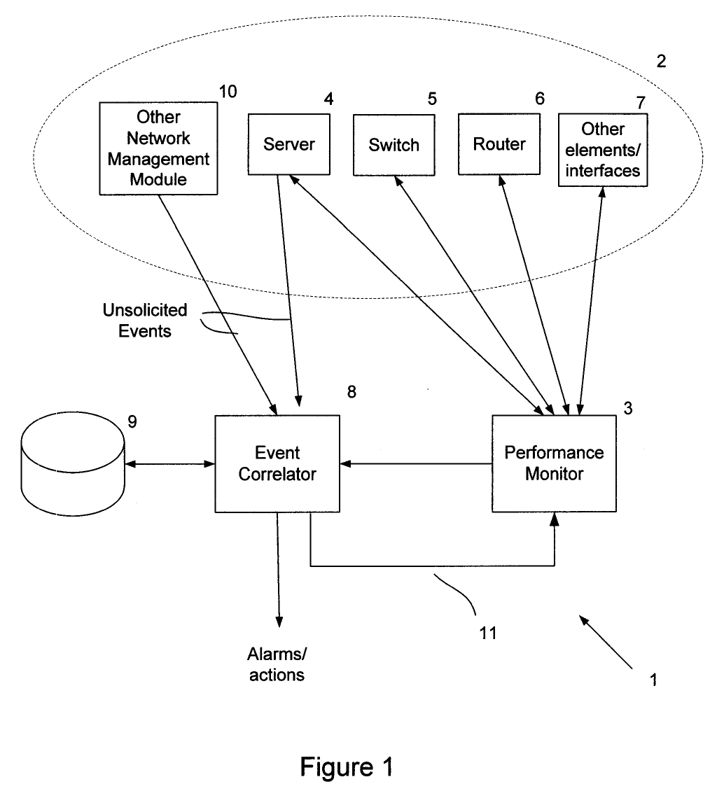

FIG. 1 illustrates a network management system 1 according to an embodiment of the invention for performing monitoring of a network 2 and event correlation. A performance monitoring tool 3, also referred to herein as a performance monitor, collects a specified set of data about a plurality of network elements, including servers 4, switches 5, routers 6 and other elements or network interfaces 7. The performance monitoring is, for example, carried out using data collection through the System Network Management Protocol SNMP. It can also be done from a number of other sources such as Cisco™ Netflow data, importing data from flat files, syslog messages and so on.

The performance monitor 3 is capable of receiving performance information and of initiating further performance data collection, for example by polling a network element for its status.

Threshold values can be set for the data collected by the performance monitor 3. The output of the performance monitor 3 is a series of events relating to threshold violations, that are input to an event correlation tool 8, also referred to herein as an event correlator, which makes correlation decisions based on a correlation database 9.

The event correlation tool 8 is also capable of receiving event data, such as alarms, from sources other than the performance monitor, and correlating such event data with event information received from the performance monitor 3. This data comprises, for example, unsolicited SNMP traps generated by SNMP agents running in the network elements 4-7 and events generated by modules 10 of the network management system, other than the performance monitor and the event correlator.

An example extract from the event correlation database 9 is shown below.

| Event | Correlation Action |
|---|---|
| Event A - interface traffic | Take action X |
| at 90% | |
| Event B - counter notification | Pass through |
| SNMP trap Y | Ignore if no more than 3 events occur in |
| | 5 minutes for the same device, otherwise |
| | issue warning |
| LinkUp_Down = DOWN | Ignore if LinkUp_Down = UP trap |
| trap received | received within 3 mins, otherwise e-mail |
| | or page operator |

Event Correlation Database Extract 1

Looking at the example events above in more detail:

Event A

If this event occurs, for example indicating that packet traffic through a particular network interface is at 90% of capacity, then the correlation action is specified as some specified action X. An example of this action X will be explained in more detail below.

Event B

If this event occurs, for example, an event intended to generate a simple notification to the operator, such as a counter exceeding a particular value, then the correlation action is specified as ‘Pass through’, which means that the correlator 8 takes no further action, and the event generated by the performance monitoring tool 3 appears at the output of the correlator 8.

SNMP Trap Y

The SNMP protocol generates trap events in response to certain status changes or problems arising on network devices. In some cases, there may be no need to take any action unless the frequency of occurrence of the traps exceeds some given threshold. In this example, the correlator 8 specifies that no warning should be issued unless more than three trap events are raised by the same device within a five minute period.

LinkUp Down=DOWN Trap Received

In this example, the SNMP trap indicating that a link is down is ignored if a trap indicating that the link is up is received within a specified time period.

The last two cases both avoid the need for an alarm condition to be propagated when the error condition is subsequently rectified or is merely a temporary occurrence.

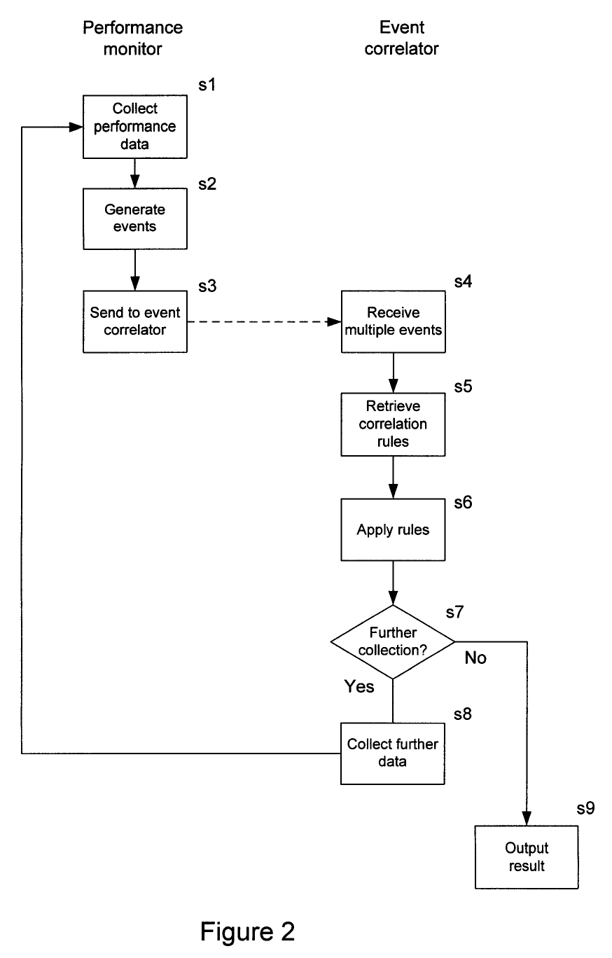

In accordance with the invention, the event correlator 8 is also capable of triggering a new set of performance data calculations based on the type of threshold violation that has occurred, as shown by the feedback loop 11 in FIG. 1. This is described further by reference to the flowchart in FIG. 2.

The performance monitoring tool 3 is pre-configured to collect a specified set of data from a specified set of network elements at specified intervals (step s1). It generates threshold alarms on detecting certain preset threshold violations (step s2) and sends these to the event correlator (step s3). The event correlator 8 receives the threshold alarms (step s4), retrieves the appropriate correlation rule for each of the alarms from the database 9 (step s5) and applies the rules in accordance with the principles set out above and explained with reference to database extract 1, to correlate events (step s6). If the rule requires the generation of further event information (step s7), then the event correlator 8 triggers a new set of performance data collection by the performance monitor 3 (step s8). Information on the type of data to collect, the frequency of collection and length of time for which to collect are preset for each type of threshold violation of interest. If no further collection is required, the event information is output (step s9).

The new set of data collections (step s1) triggered in the performance monitoring tool 3 by the event correlation tool 8 may result in a new set of threshold violations (step s2). This results in a new set of events being sent to the event correlation tool 8 (step s3), which may in turn result in a further round of data collection, and so on.

The output of the event correlation tool 8 (step s9) is a detailed set of event information that can give a good picture of real-time performance improvement or degradation in the network as a result of status changes in the network elements.

The recursive nature of this process is further illustrated by the following examples:

### EXAMPLE A

### Interface Utilisation on Interface I1 of System X goes above Threshold

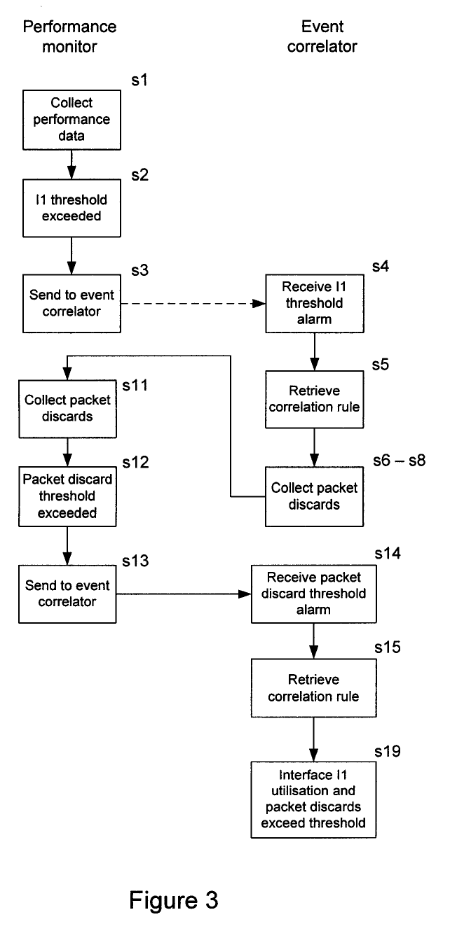

Referring to FIG. 3, the performance monitoring tool carries out monitoring of a plurality of predetermined performance metrics (step s1) and generates an interface utilisation alarm on Interface I1 (step s2). This alarm is sent to the event correlator (step s3), which receives the alarm (step s4) and retrieves the corresponding correlation rule (step s5). This rule triggers the performance monitor 3 to monitor and collect data on another performance metric, being the number of packet discards on the I1 interface (steps s6 to s8). The performance monitor 3 therefore monitors packet discards (step s11) and finds, for example, that these also exceed their preset threshold. It therefore generates an appropriate alarm (step s12), which is again sent to the event correlator (step s13). The event correlator receives the alarm (step s14) and correlates the packet discard alarm with the interface utilisation alarm (steps s15 and s16). It therefore outputs to the network operator the single alarm condition that both the interface utilisation and the packet discards on Interface I1 are above threshold (step s19). This information may assist the operator with determining the problem more efficiently.

### EXAMPLE B1

### Interface Utilisation and Packet Discard above Threshold

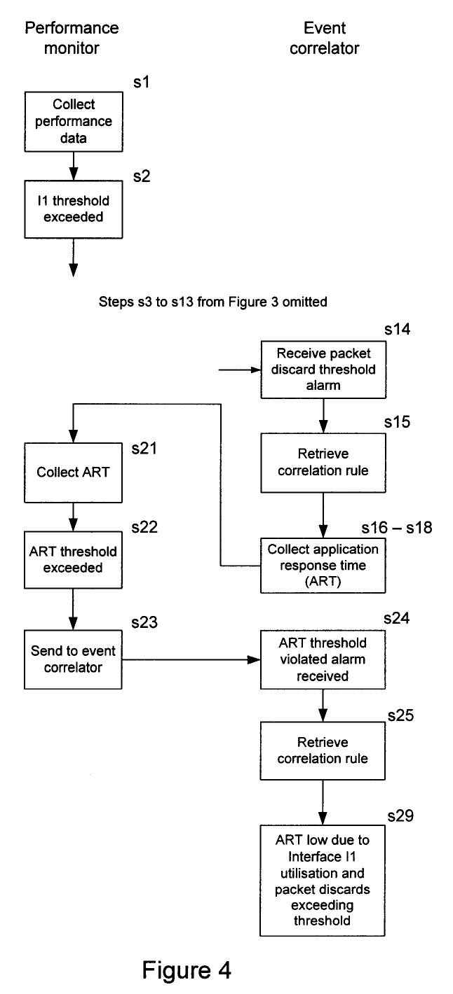

This example, illustrated in FIG. 4, follows on from example A above and assumes that the event correlator 8 has received both an interface utilisation alarm and a packet discard alarm. The description given above in relation to example A and FIG. 3 is not repeated. In this example, however, following receipt of the packet discard threshold alarm at the event correlator (step s14) the retrieved correlation rule for these two alarms (step s15) indicates that the event correlator should initiate performance data collection on application response time (ART) (step s16 to s18). Another iteration of data collection therefore follows (step s21). On the assumption that application response time violates its threshold, this generates a new alarm (step s22), which is sent to the event correlator (step s23). The event correlator receives this alarm (step s24) and retrieves the appropriate correlation rule (step s25). This correlation rule specifies that in response to the application response time alarm, if both interface utilisation and packet discards are known, then no further data collection is required, but the correlator should output the message that the application response time is low because of interface utilisation and packet discard threshold violations (step s29).

### EXAMPLE B2

### Link Down Alarm

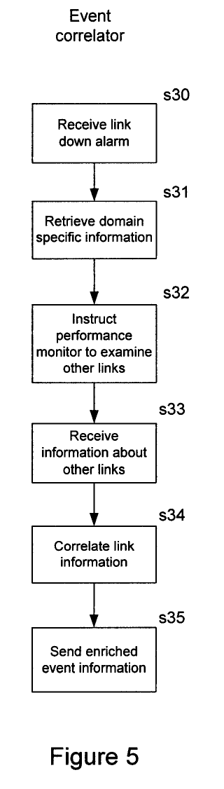

This example, illustrated in FIG. 5, shows the steps carried out at the event correlator 8 only, and assumes that the event correlator 8 receives a link down alarm from a network element directly (step s30). The link down alarm is, in this example, an unsolicited message that is not generated by the performance monitor 3. The event correlator has domain specific intelligence embedded in it that specifies that, in this case, there is a possibility of utilisation levels exceeding threshold limits on other links. The event correlator retrieves this information (step s31) and instructs the performance monitor 3 to perform collection of the relevant performance metrics on other links, for example to measure link utilisation (step s32). It then receives the resulting information from the performance monitor 3 (step s33), correlates the performance information about all of the links (step s34) and sends out an enriched event to the user that informs the user that the specific link down condition resulted in over utilisation of other links (step s35).

The output information can be displayed in the form of a graph, which can display how much each metric fell due to the other.

### EXAMPLE C

The network management module 10 shown in FIG. 1 is assumed to be a status polling engine. One of its tasks is to perform Internet Control Message Protocol (ICMP) pings on the network elements and determine if each element is reachable from the module 10 or not. If a network element is not reachable, then the status polling engine generates an event, referred to herein as an ICMP Unreachable event, to indicate the condition to other modules of the network management system such as the event correlation module 8. The sequence of events is set out below.

The event correlation tool 8 first receives a threshold violation event for CPU utilization for a router 6 from the performance monitor 3 at time t1 (step s40). The event correlation tool is configured to hold the CPU threshold violation event for 10 minutes and hence holds the event information in memory (step s41). The status polling engine generates an ICMP Unreachable event for the router's interface I1 at time t1+5 minutes. At t1+6 minutes, the event correlation tool 8 receives the ICMP Unreachable event for interface I1 from the polling engine (step s43). The event correlation tool correlates the CPU utilization threshold violation event held in memory and the ICMP Unreachable event received in step 43 and generates an event to the user (step s44) that informs him that the interface I1 in the router 6 is not really down, but the router is not able to respond to ICMP pings because of its high CPU utilization.

It will be appreciated that the above described system allows for incremental knowledge gain in real-time, which provides for enriched event information, as well as the measurement of real-time performance degradation.

The above embodiments have described a performance monitoring tool and an event correlation tool. These tools would typically be software modules running on a conventional server computer connected to the network to be analysed. The modules could also be implemented in distributed form. The modules may be embodied as computer programs stored on a medium such as ROM, RAM or on optical or magnetic storage devices. However, it will be understood by the skilled person that these tools could be implemented in any suitable manner, in any combination of software, hardware or firmware.

It will further be understood by the skilled person that many variations from the above described embodiments are possible while still falling within the scope of the claims. For example, the precise functionality described for each of the performance monitor and the event correlator could be split between these modules in different ways to achieve the overall function of the performance monitor and event correlator.

1. A method of monitoring performance in a network, comprising:
collecting performance data from in the network;
generating events based on the performance data;
correlating the events; and
initiating further collection of performance data in dependence on the results of the correlation.

2. The method according to claim 1, wherein the perfromance data comprises information realating to a plurality of performance metrics, and the step of initating collection of further performance data comprises initiating monitoring of a further performance metric.

3. The method according to claim 2, further comprising receiving the further performance metric, generating further events based on said performance metric and correlating the events with the further events.

4. The method according to claim 3, further comprising the step of initiating one or more further stages of performance data collection in dependence on the result of said correlation.

5. The method according to claim 1, comprising correlating events in accordance with one or more correlation rules.

6. The method according to claim 1, comprising generating an event when the performance data breaches a predetermined theshold value.

7. A system for monitoring performance in network, comprising:
means for collecting performance data from the network;
means for generating events based on the performance data;
means for correlating the vents; and
means for initiating further collection of performance data in dependence on the result of the correlation.

8. The system according to claim 7, wherein the correlating means are arranged to correlate the events based on correlation rules stored in a correlation database.

9. The system according to claim 7, wherein the performance data comprises one or more performance metrics relating to one or more network elements.

10. The system according to claim 9, wherein the network elements comprise one or more elements selected from the group comprising servers, switches, routers and network interfaces.

11. The system according to claim 7, wherein the correlating means is arranged to receive the events from the generating means.

12. The system according to claim 11, wherein the correlating means is further arranged to receive events from sources external to the generating means.

13. The syetem according to claim 12, wherein the correlating means is arranged to correlate the events received from the generating means with the events generated from sources external to the generating means.

14. A system for monitoring performance in a network, comprising:
a performance monitor for collecting performance data relating to network elements in the network and for generating event data based on said performance data; and
an event correlator for receiving the event data from the performance monitor and for correlating the event data, wherein
the event correlator is arranged to instruct the performance monitor to initate further collection of further performance data in dependence on the result of the correlation.

15. The system according to claim 14, wherein the event correlator is arranged to receive external event data from sources external to the performance monitor and to correlate the event data generated by the performance monitor with the external event data.

16. The system according to claim 14, wherein the performance monitor is arranged to generate further event data based on the further performance data and the event correlator is arranged to correlate the event data and/or the external event data with the further event data.

17. The system according to claim 14, wherein the performance data comprises real time performance metrics based on information relating to real time staus changes of the network elements.

18. A computer program, which when executed by a computer, is arranged to carry out the method of claim 1.

19. The method according to claim 2, further comprising receiving the further performance metric, generating further events based on said performance metric and correlating the events with the further events.

20. The systen according to claim 8, wherein the performance data comprises one or more performance metrics relating to one or more network elements.
